(19) United States
(12) Patent Application Publication
(10) Pub. No.: US 2011/0140882 A1
(43) Pub. Date: Jun. 16, 2011

(54) EMERGENCY ALERT SYSTEM AND METHOD THEREOF, AND RELAY DEVICE

(75) Inventor: Dong Won JANG, Daejeon (KR)

(73) Assignee: ELECTRONICS AND TELECOMMUNICATIONS RESEARCH INSTITUTE, Daejeon (KR)

(21) Appl. No.: 12/893,800

(22) Filed: Sep. 29, 2010

(30) Foreign Application Priority Data
Dec. 10, 2009 (KR) 10-2009-0122688
Feb. 2, 2010 (KR) 10-2010-0009715

(51) Int. Cl. G08B 1/08

(52) U.S. Cl. 340/539.13; 340/539.11

(57) ABSTRACT

An emergency alert system includes an alert device, a relay device, and a security device. When a signal-generating-button click signal is sensed, the alert device generates a first alert signal including identification information stored in advance, and transmits the first alert signal to the relay device by using a local wireless communication protocol. The relay device receives the first alert signal from the alert device, extracts the identification information, generates a second alert signal including the identification information and location information of the relay device, and transmits the second alert signal to the security device by using a preset dedicated wireless protocol.

### CROSS-REFERENCE TO RELATED APPLICATION

This application claims priority to and the benefit of Korean Patent Application Nos. 10-2009-0122688 and 10-2010-0009715 filed in the Korean Intellectual Property Office on Dec. 10, 2009, and Feb. 2, 2010, the entire contents of which are incorporated herein by reference.

### BACKGROUND OF THE INVENTION

(a) Field of the Invention

The present invention relates to an emergency alert system and a method thereof, and a relay device.

(b) Description of the Related Art

Various security systems are operating in various fields, the security systems being capable of alerting, to the external, an emergency arising at a location where it is difficult to receive immediate help from other people. However, the security systems are not widely spread due to the complexity of procedures, diversified operations, economic feasibility, etc.

In general, such security systems use telephone networks or closed-circuit television (CCTV) networks using dedicated lines. However, since emergency contact networks operating by such telephone networks or dedicated lines have a matter of procedure in individual's contact in case of emergency, they are not for practical use. Further, individual operation by a dedicated network is very uneconomical and inefficient.

Moreover, in a case of using a telephone network, in order for a person to ask for help, the person should necessarily carry a phone, call, for example, a public office by pressing a phone number, and explain his location and information on him in his voice or transmit position information that the portable terminal measures. However, in the case of using a telephone network, since dial-up connection is impossible in a situation in which the portable phone is in a shadow region or turned off, it is impossible to ask for help.

In particular, in a case of sea, since using a telephone network is limited at most regions, a separate security system should be established. Currently, ships for international navigation construct a security network for crime prevention with security equipment referred to as an ship security alerting system (SSAS) which is loaded thereon and uses a satellite. However, in a case of small ships or finish boats for cabotage, it is almost impossible to use security equipment because of cost. Further, since coastal communication networks have not been digitalized yet, if cost and technical problems are not solved, immediate implement is difficult.

Meanwhile, in a case of a CCTV network, since information of all cameras should be monitored in real time or recorded, the financial burden is high. For this reason, it is not for practical use.

Also, in a case of alarm bells for banks, since a high-priced dedicated line should be used, they are used in limited regions.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an emergency alert system and a method having advantages of immediately informing an emergency services organization of identification information of a person asking for help and an occurrence location of a current emergency by only a minimal motion of pressing a signal generation button by the person asking for help when an emergency arises.

An exemplary embodiment of the present invention provides an emergency alert system. The system includes:

an alert device for generating a first alert signal including identification information stored in advance when a signal-generating-button click signal is sensed, and transmitting the first alert signal by using a local wireless communication protocol; a relay device for receiving the first alert signal, extracting the identification information from the first alert signal, generating a second alert signal including the identification information and location information of the relay device, and transmitting the second alert signal by a predetermined dedicated wireless protocol in which a common channel of a specific frequency band assigned to transmit and receive urgent wireless signals to and from an emergency services organization is set; and a security device for receiving the second alert signal from the relay device by using the dedicated wireless protocol, wherein the relay device is positioned at a region where it is capable of communication with the alert device by using the local wireless communication protocol.

Another exemplary embodiment of the present invention provides an emergency alert method. The method includes;

receiving, by a relay device, a first alert signal, wherein the relay device is positioned at a region where it is capable of communication with an alert device by using a local wireless communication protocol and generates the first alert signal including identification information stored in advance when a signal-generating-button click signal is sensed; and transmitting, by the relay device, a second alert signal to a terminal of a security device installed in an emergency services organization or installed in a terminal or a vehicle of an emergency rescue worker by a preset dedicated wireless protocol in which a common channel of a specific frequency band assigned to transmit and receive urgent wireless signals to and from the emergency services organization is set.

Yet another embodiment of the present invention provides a relay device. The relay device includes;

a receiver for demodulating a received first alert signal by using a local wireless communication protocol and extracting identification information included in the first alert signal; a storage unit for storing location information of the relay device; and a transmitter for generating a second alert signal including the identification information and the location information of the relay device and transmitting the second alert signal by using a preset dedicated wireless protocol in which a common channel of a specific frequency band assigned to transmit and receive urgent wireless signals to and from the emergency services organization is set.

### BRIEF DESCRIPTION OF THE DRAWINGS

FIG. 1 is a diagram illustrating a configuration of an emergency alert system according to an exemplary embodiment of the present invention;

FIG. 2 is a block diagram illustrating a detailed configuration of the alert device according to the exemplary embodiment of the present invention;

FIG. 3 is a block diagram illustrating a detail configuration of the relay device according to the exemplary embodiment of the present invention;

FIG. 4 is a block diagram illustrating a detailed configuration of the security device according to the exemplary embodiment of the present invention; and

FIG. 5 is a flowchart illustrating an emergency alert method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In specification, unless explicitly described to the contrary, the word “comprise” and variations such as “comprises” or “comprising”, will be understood to imply the inclusion of stated elements but not the exclusion of any other elements.

Hereinafter, an emergency alert system according to an exemplary embodiment of the present invention will be described in detail with reference to accompanying drawings.

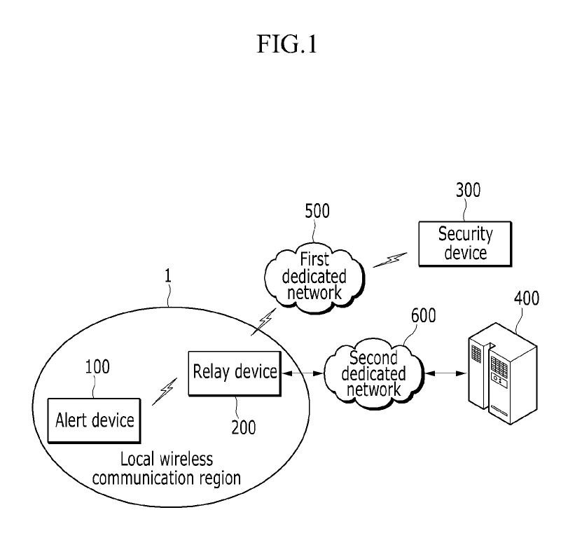

FIG. 1 is a diagram illustrating a configuration of an emergency alert system according to an exemplary embodiment of the present invention.

Referring to FIG. 1, an emergency alert system includes an alert device 100, a relay device 200, a security device 300, and a rescue center 400.

The alert device 100 is a personal portable wireless low-output device. The alert device 100 may be implemented in a small-sized chip form by using active radio-frequency identification (RFID) or remote keyless entry (RKE) technology to be capable of installed in a personal portable product. Here, examples of the personal portable product include an electronic watch, a portable phone, an MP3 (moving picture experts group_{—}1audio layer 3) player, etc.

The relay device 200 is installed at a specific region 1 where the relay device 200 is capable of local wireless communication with the alert device 100. The specific region 1 capable of local communication is a region having a radius in a range of about 100 m to 200 m.

The relay device 200 may be installed at an unsecured zone, that is, a place where it is difficult to receive immediate help from other people such as an alloy, the vicinity of a school, a mountainous area, a ship at sea, etc. Also, the relay device 200 may be implemented in an additional function form by installing at the same location as an existing security light or a closed-circuit television (CCTV) camera.

The security device 300 is mounted on a terminal, which an emergency rescue worker such as a policeman or a 911 ambulance worker carries, or communication equipment installed in a vehicle for emergency rescue workers, or installed in an emergency services organization such as a 911 center. When the security device 300 is mounted on a moving object such as a vehicle and a ship, updating for the location information of the security device 300 is performed through a global positioning system (GPS).

The rescue center 400 means an organization, which is capable of taking appropriate measures when an emergency arises, such as the National Police, a 911 center or a coast station.

Here, the alert device 100 and the relay device 200 perform local wireless communication protocol communication. A local wireless communication protocol means a protocol capable of data transmission and reception between various pieces of digital equipment by use of a radio frequency without physical cables.

Meanwhile, the relay device 200 is connected to the security device 300 through a first dedicated network 500 using a predetermined dedicated wireless protocol.

In a dedicated wireless protocol, a common channel that an emergency services organization determines in advance to transmit and receive wireless emergency signals is set.

The common channel means a frequency channel assigned to, for example, a radio that a policeman carries, a patrol car, etc. Also, the common channel includes a specific frequency band for safety of life and distress which a coast station assigns to, for example, an automatic identification system (AIS) network to receive information on ship's location and sailing by wireless data communication.

Also, the relay device 200 is connected to the rescue center 400 through a second dedicated network 600 to be capable of wire communication.

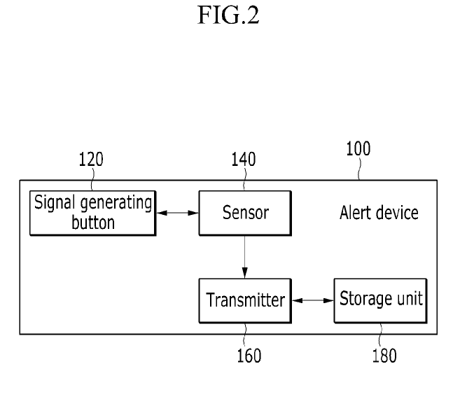

Now, specific functions of the alert device 100, the relay device 200, and the security device 300 will be described with reference to FIGS. 2, 3, and 4.

First, FIG. 2 is a block diagram illustrating a detailed configuration of the alert device according to the exemplary embodiment of the present invention.

Referring to FIG. 2, the alert device 100 includes a signal generating button 120, a sensor 140, a transmitter 160, and a storage unit 180.

The signal generating button 120 is a means that is installed outside the alert device 100 and is pushed by a user in an emergency to start a process of generating a first alert signal. If the signal generating button 120 is pushed by the user, it generates a signal-generating-button click signal.

The sensor 140 is connected to the signal generating button 120 and senses whether a signal-generating-button click signal has been generated.

If the sensor 140 senses that a signal-generating-button click signal has been generated, the transmitter 160 generates a first alert signal including pre-stored identification information. Then, the transmitter 160 transmits the first alert signal to the relay device 200 by using a local wireless communication protocol according to predefined local wireless interfaces standards.

At this time, the transmitter 160 encodes the first alert signal by an encoding algorithm consulted with the relay device 200 and then transmits the first alert signal, thereby preventing the leaking of private information.

The storage unit 180 includes the identification information to be included in the first alert signal and information on the predefined local wireless interface standards.

Here, the identification information is unique information for identifying a person carrying the alert device 100 and includes his name, social security number, school, address, etc. Such identification information may be input in advance by an input unit (not shown) provided in the alert device 100 and be stored in the storage unit 180. Alternatively, the identification information may be uploaded in the storage unit 180 through a separate data cable.

Further, the predefined local wireless interface standards may include, for example, infrared communication (IrDA) standards, and Bluetooth standards.

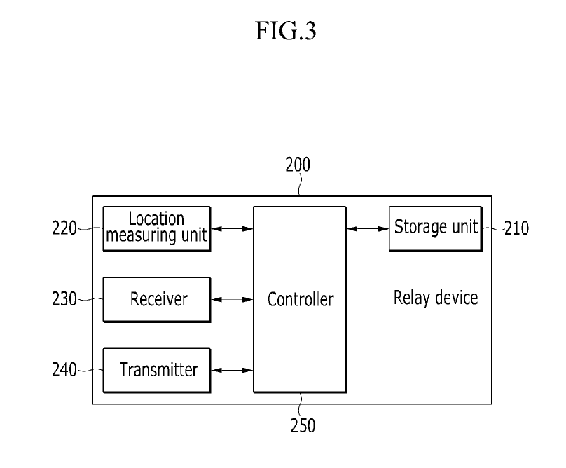

Next, FIG. 3 is a block diagram illustrating a detail configuration of the relay device according to the exemplary embodiment of the present invention.

Referring to FIG. 3, the relay device 200 includes a storage unit 210, a location measuring unit 220, a receiver 230, a transmitter 240, and a controller 250.

The storage unit 210 stores location information and communication information of the relay device 200. Here, the communication information includes information on a dedicated wireless protocol and a local wireless protocol.

At this time, the initial location information of the relay device 200 is the same as the location information of a place where the relay device 200 is installed.

Further, the storage unit 210 may store information on a plurality of dedicated wireless protocols having different common channels set therefor. At this time, the different common channels mean common channels of specific frequency bands assigned to emergency services organizations, respectively. That is, since a common channel used for police work is supposed to be different from a common channel used for 911 centers, those common channels are set respectively.

The location measuring unit 220 measures the current location of the relay device 200 by using a signal periodically received from a GPS satellite.

At this time, the location measuring unit 220 is a component selectively mounted on the relay device 200. If the installation location of the relay device 200 is fixed, the location measuring unit 220 may not be mounted on the relay device 200. For example, when the relay device 200 is installed on the ground, sine the location of the installation place is fixed, the initial location information input in advance does not change. However, when the relay device 200 is mounted on a ship at sea, the ship continuously moves, which makes the initial location information different from the current location information. Therefore, the location measuring unit 220 should be mounted to measure and consecutively update the current location information.

The receiver 230 receives the first alert signal from the alert device 100 by local wireless communication protocol communication with reference to the communication information stored in the storage unit 210.

The receiver 230 demodulates and decodes the first alert signal by a decoding algorithm consulted with the alert device 100 and extracts the identification information.

The transmitter 240 generates a second alert signal including the identification information extracted by the receiver 230 and the location information of the relay device 200. Then, the transmitter 240 transmits the second alert signal to the security device 300 by a dedicated wireless protocol communication with reference to the communication information stored in the storage unit 210.

Further, the transmitter 240 transmits the identification information extracted by the receiver 230 and the location information of the relay device 200 while performing urgent rescue request to the rescue center 400 through the second dedicated network 600 connected to the rescue center 400.

The controller 250 controls an organized operation of detailed constituent elements of the relay device 200, is connected to the storage unit 210, the location measuring unit 220, the receiver 230, and the transmitter 240, and controls the operation of each of them.

In particular, when the location measuring unit 220 is mounted on the relay device 200, if the location information periodically measured by the location measuring unit 220 does not coincide with the location information stored in the storage unit 210, the location information measured by the location measuring unit 220 is updated in the storage unit 210. That is, the initial location information of the relay device 200 is deleted and the location information measured by the location measuring unit 220 is stored as the location information of the relay device 200.

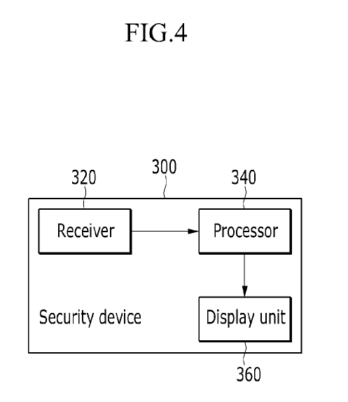

Finally, FIG. 4 is a block diagram illustrating a detailed configuration of the security device according to the exemplary embodiment of the present invention.

Referring to FIG. 4, the security device 300 includes a receiver 300, a processor 340, and a display unit 360.

The receiver 300 receives the second alert signal from the relay device 200 by using a dedicated wireless protocol.

The processor 340 receives the second alert signal from the receiver 300, demodulates the second alert signal, and extracts the identification information and the location information of the relay device 200.

The display unit 360 displays the location information of the relay device 200 and the identification information extracted by the processor 340 on a screen.

Next, a series of processes of an emergency alert method will be described on the basis of the above-mentioned configuration.

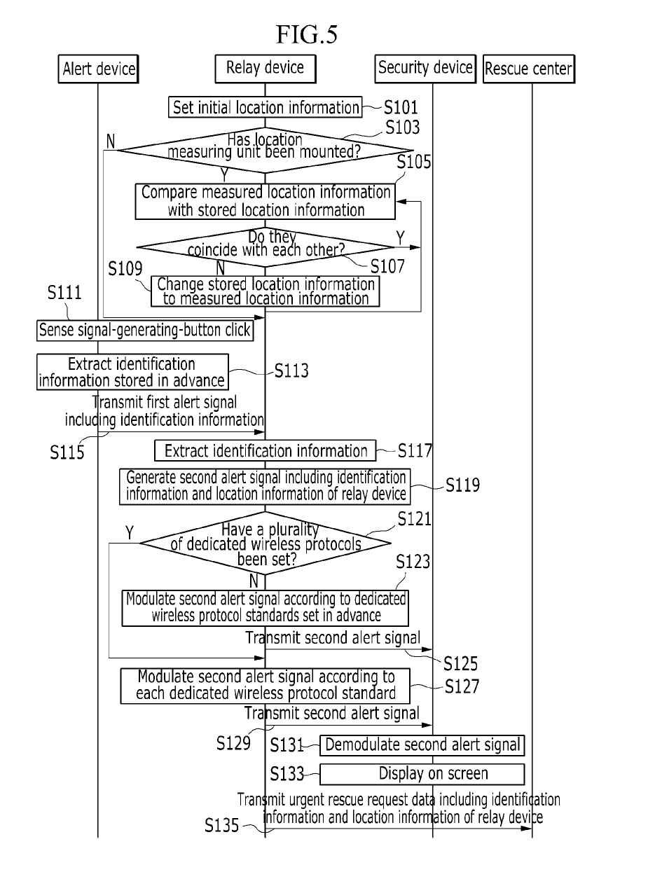

FIG. 5 is a flowchart illustrating an emergency alert method according to an exemplary embodiment of the present invention. At this time, the same constituent elements as shown in FIGS. 1 to 4 are described by using the same reference numerals.

Referring to FIG. 5, the controller 250 of the relay device 200 sets the location information of the installation place of the relay device 200 as the initial location information of the relay device 200 (S101) and stores the initial location information in the storage unit 210 of the relay device 200.

The controller 250 of the relay device 200 determines whether the location measuring unit 220 has been mounted (S103). If it is determined that the location measuring unit 220 has been mounted, the controller 250 compares the location information measured by the location measuring unit 220 with the location information stored in the storage unit 210 and determines whether they coincide with each other (S105 and S107). At this time, when Step S105 is first performed, the location information measured by the location measuring unit 220 is compared with the initial location information to determine whether they coincide with each other.

If they coincide with each other, the procedure returns to Step S105. If they do not coincide with each other, the location information of the relay device 200 is changed to the location information measured by the location measuring unit 220 (S109). Next, whenever the location measuring unit 220 periodically measures the location information Steps S105 and S107 are repeated.

Subsequently, if the sensor 140 of the alert device 100 senses the signal-generating-button click signal (S111), the transmitter 160 of the alert device 100 extracts the identification information stored in advance (S113), and transmits the first alert signal including the identification information to the relay device 200 by using the local wireless communication protocol (S115).

The receiver 230 of the relay device 200 extracts the identification information from the first alert signal received in Step S115 (S117).

Then, the transmitter 240 of the relay device 200 generates the second alert signal including the identification information and the location information of the relay device 200 stored in the storage unit 210 of the relay device 200 (S119).

Next, the controller 250 of the relay device 200 determines whether a plurality of dedicated wireless protocols have been set (S121). That is, the controller 250 determines whether a plurality of common channels for use in different emergency services organizations have been set.

If the plurality of dedicated wireless protocols have not been set, the controller 250 of the relay device 200 controls the transmitter 240 to modulate the second alert signal by using the dedicated wireless protocol stored in the storage unit 210 of the relay device 200 (S123). Then, the transmitter 240 transmits the modulated second alert signal to the security device 300 (S125).

In contrast, if the plurality of dedicated wireless protocols have been set, the controller 250 of the relay device 200 controls the transmitter 240 to modulate each second alert signal according to the plurality of dedicated wireless protocol standards (S127). Then, the transmitter 240 transmits each second alert signal to the security device 300 (S129).

Subsequently, the processor 340 of the security device 300 receives the second alert signal, demodulates the second alert signal (S131), and extracts the identification information and the location information of the relay device. The display unit 360 displays the extracted information (S133).

Meanwhile, the transmitter 240 of the relay device 200 transmits urgent rescue request data including the identification information and the location information of the relay device 200 through the second dedicated network 600 to the rescue center 400 (S135).

According to an exemplary embodiment of the present invention, when an emergency arises, an individual being in a crisis situation can easily inform an emergency services organization of his identification information and location by only clicking a signal generation button of his portable alert device. Further, the emergency services organization can easily locate a person asking for help in a crisis situation and immediately take appropriate measures.

Furthermore, since a relay device operating in association with an alert device transmits a signal asking for emergency help by use of a specific frequency band assigned to each existing emergency services organization, it is possible to implement a more effective national security network integrated with existing security systems. Therefore, it is possible to save infrastructure and manpower to newly implement a separate dedicated network for asking for emergency help and to solve an unreasonable procedure in operation and cost.

The above-mentioned exemplary embodiments of the present invention are not embodied only by an apparatus and/or method. Alternatively, the above-mentioned exemplary embodiments may be embodied by a program performing functions, which correspond to the configuration of the exemplary embodiments of the present invention, or a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An emergency alert system comprising:
an alert device for generating a first alert signal including identification information stored in advance when a signal-generating-button click signal is sensed, and transmitting the first alert signal by using a local wireless communication protocol;
a relay device for receiving the first alert signal, extracting the identification information from the first alert signal, generating a second alert signal including the identification information and location information of the relay device, and transmitting the second alert signal by a predetermined dedicated wireless protocol in which a common channel of a specific frequency band assigned to transmit and receive urgent wireless signals to and from an emergency services organization is set; and
a security device for receiving the second alert signal from the relay device by using the dedicated wireless protocol,
wherein the relay device is positioned at a region where it is capable of communication with the alert device by using the local wireless communication protocol.

2. The system of claim 1, wherein:
the relay device includes
a receiver for receiving the first alert signal, demodulating the first alert signal, and extracting the identification information,
a storage unit for storing location information of the relay device wherein location information of a place where the relay device is installed is set as initial location information, and
a transmitter for generating and transmitting the second alert signal including the identification information extracted by the receiver and the location information of the relay device stored in the storage unit.

3. The system of claim 2, wherein:
the relay device further includes
a location measuring unit for measuring the location of the relay device by using a signal periodically received from a global positioning system (GPS) satellite, and
a controller for comparing the location information measured by the location measuring unit with the initial location information when the location measuring unit is mounted, and updating the location information of the relay device with the measured location information if the location information measured by the location measuring unit does not coincide with the initial location information.

4. The system of claim 2, wherein:
the security device is provided in plural and the plurality of security devices respectively use a plurality of dedicated wireless protocols in which common channels of specific frequency bands different from each other are set,
the storage unit of the relay device stores information on the plurality of dedicated wireless protocols, and
the transmitter of the relay device modulates the second alert signal according to each of the plurality of dedicated wireless protocols and transmits the modulated second alert signal to each security device using the corresponding dedicated wireless protocol when the information on the plurality of dedicated wireless protocols are stored in the storage unit of the relay device.

5. The system of claim 1, wherein:
the alert device includes
a signal generating button installed on the outside,
a sensor connected to the signal generating button and for sensing the signal-generating-button click signal generated from the signal generating button,
a storage unit for storing private identification information of a user carrying the alert device, and
a transmitter for extracting the private identification information from the storage unit, generating the first alert signal including the private identification information, and transmitting the first alert signal when the sensor senses the signal-generating-button click signal.

6. The system of claim 5, wherein:
the security device includes
a receiver for receiving the second alert signal from the relay device,
a processor for demodulating the second alert signal by using information according to a predetermined dedicated wireless protocol standard and extracting the identification information and the location information of the relay device, and
a display unit for displaying the identification information and the location information of the relay device on a screen.

7. An emergency alert method comprising:
receiving, by a relay device, a first alert signal, wherein the relay device is positioned at a region where it is capable of communication with an alert device by using a local wireless communication protocol and generates the first alert signal including identification information stored in advance when a signal-generating-button click signal is sensed; and
extracting, by the relay device, the identification information from the first alert signal and generating a second alert signal including the identification information and location information of the relay device; and
transmitting, by the relay device, the second alert signal to a terminal of a security device installed in an emergency services organization or installed in a terminal or a vehicle of an emergency rescue worker by a preset dedicated wireless protocol in which a common channel of a specific frequency band assigned to transmit and receive urgent wireless signals to and from the emergency services organization is set.

8. The method of claim 7, wherein:
the generating of a second alert signal includes
demodulating the first alert signal and extracting the identification information, and
generating the second alert signal including the identification information and the location information of the relay device, stored in advance, wherein location information of a place where the relay device is installed is set as initial location information.

9. The method of claim 8, further comprising:
before the receiving,
setting the location information of a place where the relay device is installed as the initial location information;
measuring the location of the relay device by using a signal periodically received from a global positioning system (GPS) satellite, and
comparing the measured location information with the initial location information, and updating the location information of the relay device with the measured location information if the measured location information does not coincide with the initial location information.

10. The method of claim 8, wherein:
the transmitting includes
when a plurality of dedicated wireless protocols are set, modulating the second alert signal according to each of the plurality of dedicated wireless protocols, and
transmitting a plurality of modulated second alert signals to security devices using corresponding dedicated wireless protocols, respectively.

11. A relay device comprising:
a receiver for demodulating a received first alert signal by using a local wireless communication protocol and extracting identification information included in the first alert signal;
a storage unit for storing location information of the relay device; and
a transmitter for generating a second alert signal including the identification information and the location information of the relay device and transmitting the second alert signal by using a preset dedicated wireless protocol in which a common channel of a specific frequency band assigned to transmit and receive urgent wireless signals to and from the emergency services organization is set.

12. The relay device of claim 11, wherein:
the storage unit stores initial location information set to location information of a place where the relay device is installed.

13. The relay device of claim 12, further comprising:
a location measuring unit for measuring the location of the relay device by using a signal periodically received from a global positioning system (GPS) satellite, and
a controller for comparing the location information measured by the location measuring unit with the initial location information when the location measuring unit is mounted, and updating the location information of the relay device with the measured location information if the location information measured by the location measuring unit does not coincide with the initial location information.

14. The relay device of claim 12, wherein:
the storage unit stores information on a plurality of dedicated wireless protocols in which common channels of specific frequency bands different from each other are set, and
the transmitter modulates the second alert signal according to each of the plurality of dedicated wireless protocols and transmitting the modulated second alert signal to each security device using the corresponding dedicated wireless protocol.
